(19) United States
(12) Patent Application Publication
(10) Pub. No.: US 2016/0234991 A1
(43) Pub. Date: Aug. 18, 2016

(54) Simple, rugged, and durable method of adjusting, selecting, and fixing the depth of cut of a sod cutter and surface planer without the use of tools

(71) Applicant: Todd Michael Tilton, South Lyon, MI (US)

(72) Inventor: Todd Michael Tilton, South Lyon, MI (US)

(21) Appl. No.: 15/004,971

(22) Filed: Jan. 24, 2016

Related U.S. Application Data
(60) Provisional application No. 62/117,512, filed on Feb. 18, 2015.

(51) Int. Cl. A01B 45/04

(52) U.S. Cl. CPC A01B 45/04

(57) ABSTRACT

A method of adjusting the depth of cut of a sod or other vegetation cutting or surface planer device achieved through the use of two pairs of vertically aligned slidably engaged plates on parallel planes, one pair of plates attached to the depth limiting device of the sod cutter and the other pair attached to the rigid frame of the sod cutter, in each pair of plates, the plate that is oriented closest to the other assembly is arranged to be in between the other pair of plates, each plate in a pair containing the same number of a plurality of banks of matching orifices in a specific pattern that coincide with the specific matched pattern of orifices in the other pair of plates and fixed in relative vertical position to each other by linchpins inserted through aligned orifices in each of the pairs of plates.

### CROSS-REFERENCE TO RELATED APPLICATIONS

Not applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This disclosure relates generally to earth working equipment and more specifically to equipment used to cut sod or vegetation to multiple, adjustable, and specific depths below grade or to plane the surface of the ground to multiple, adjustable, and specific depths.

In the context of construction, renovation, or maintenance of any landscape arrangement it is often necessary to remove the existing vegetation on a site so as to allow for the working and shaping of the, earth or to remove the certain species of vegetation that is existing. This removal includes the visible (above ground) plant material as well as varying and specific amounts of the root structure which is underground. Another reason to remove the vegetation is to preserve and protect it from damage for the purposes of re-installation after the necessary work has been accomplished on the site where it is existing or to move it to another site. It is also desirable to loosen or cut soil to specific depths for the purposes of removing a specified depth of soil or layer of material in the soil or to loosen the soil in preparation of planting new vegetation. In related industries, it is desirable to non-destructively remove vegetation, along with a specific depth of the soil in which it is currently growing, from its existing location for the purposes of selling the vegetation.

Machines and attachments for demolition, roto-tilling, cutting sod, and harvesting vegetation are well known in the art. Many of these devices involve very complicated machinery and motors or power take-off devices that provide for spinning, oscillating, or vibrating the cutting devices in various manners. The moving parts in these devices require frequent maintenance and often break and require expensive repair or replacement. Many of these devices are built to a specific depth of cut which is not adjustable or if the depth of cut is adjustable the process for making adjustments to the depth of cut is a complicated process that involves the use of hand or power tools, or there are only a limited number of depth of cut positions available. Oftentimes the device for limiting the depth of cut is a wheel or roller which has its axle fixed to the device at a specified height above the cutting device so that when the cutting device is engaged in the soil the wheel or roller rolls on top of the ground surface. Those devices which are designed to be pulled by tractors rely upon the weight of the device or implement to remain engaged with (and under) the ground. Depending upon ground conditions these devices may be ineffective for their stated purpose or require additional weight to be added to the device to increase its effectiveness. Other devices such as bulldozer blades and loader buckets are effective for removal of vegetation or layers of soil but do not have features which consistently limit the depth of cut. Bulldozer blades and loader buckets are also somewhat slow and messy and destroy the vegetation in the process of separating it from the soil, and also require an expertly skilled master operator in order to achieve desirable results. In all of these devices the moving parts, complicated designs, limited adjustability, and requisite operating skills make them expensive and inefficient to purchase, maintain, and operate.

There is a need for a simple, rugged, and durable method of adjusting the depth of cut of sod and vegetation cutting and surface planning devices with a plurality of incremental depth adjustment options that do not require tools to adjust that can be successfully operated by the novice and master operator alike.

### BRIEF SUMMARY OF THE INVENTION

The invention is a method of adjusting the depth of cut of a sod or other vegetation cutting or surface planer device. This is achieved through the use of two pairs of vertically aligned slidably engaged plates on parallel planes. One pair of plates is attached to the depth limiting device of the sod cutter and the other pair is attached to the rigid frame of the sod cutter. In each pair of plates, the plate that is oriented closest to the other assembly is arranged to be in between the other pair of plates. Each plate in a pair contains the same number of a plurality of banks of matching orifices in a specific pattern that coincide with the specific matched pattern of orifices in the other pair of plates in such a way that multiple incremental adjustments can be made to the relative position of the plates and the assemblies to which they are fixed by removing the steel pins from specific orifices in the pattern, changing the relative position of the assemblies, and then reinserting the steel pins in to the newly aligned sets of orifices, locking the relative position of the assemblies and their attached plates utilizing steel pins that can be inserted and removed without the use of tools. The orifices and their pattern in a given pair of plates attached to the same assembly of the device are identical to each other. The patterns of orifices of one pair of plates is complementary and coincidental to the pattern of orifices in the other pair of plates.

The assemblies of the device consist of a rigid frame, a cutting device, and a depth limiting device. When the invention is in operation, there are no oscillating, vibrating, spinning, or otherwise moving parts on the invention, ensuring that it will be the most simple and economical to purchase, own, operate, and maintain. The cutting device of the invention will be forced in to the ground during operation by the power and ground traction of the tool carrier, tractor, or the like to which the device is attached. The maximum depth to which the cutting device can be forced in to the ground will be limited by the depth limiting device, which is a ski with sufficient surface area in contact with the ground to prevent the tool carrier from forcing the cutting device deeper than the depth limiting device is set to allow. The cutting device is a wear item and when it is worn or damaged it is the only part of the invention that should need to be replaced. Removal and replacement of the cutting device is inexpensive and simple, being accomplished by the removal of nuts and bolts using simple hand tools or hand held power tools. The effectiveness of the work done by the invention will be determined by the power and ground traction of the tool carrier, tractor, or the like and not solely by its own weight or motive forces as is the case for many of the other devices that currently exist to do this work. Because of the depth limiting device and simple nature of the invention the only skill required to operate it will be the minimum skill required to operate the tool carrier, tractor, or the like. The preferred form of this device is fabricated from steel with the permanent connections being welded.

In accordance with the preferred form of the invention the rigid frame consists of three vertically oriented “uprights”, a tool carrier connection plate arranged at the rear of the assembly for connecting to the tool carrier or the like, a vertically oriented front plate and a vertically oriented rear plate (one pair of plates with identical orifices) both arranged at the front of the assembly, as well as diagonal supports, such that all of these members are connected to each other and when viewed from the top, or in plan view, they form a rectangular frame with diagonal members providing rigidity of shape. In general, when viewed from the top the frame will be as open as possible, without any obstructions that may cause clogging of the cutting device.

The vertically oriented uprights of the rigid frame are arranged parallel to each other and the direction of travel of the machine to which this device is attached. The uprights have a plurality of attachment points that allow for securing the cutting device to the uprights in a fashion that allows for zero relative movement between the frame and cutting device during operation, but also allows for the efficient and economical removal and replacement of the standardized cutting device if the cutting device were to become damaged or worn to the point that it is no longer effective. In the preferred form of the invention bolts with properly tightened nuts secure the cutting device to the rigid frame.

The vertically oriented front and rear plates (matched pair) of the rigid frame will be oriented perpendicular to the previously mentioned vertically oriented uprights and the direction of travel and will be attached to the leading edge of the vertically oriented uprights. The plates will be spaced apart from each other and fixed in place the minimum amount of sufficient distance to allow the rear plate of the depth limiting device to slidably engage with this pair.

In accordance with the preferred form of the invention the cutting device consists of a horizontally oriented member with a sharpened leading edge permanently fixed to as many vertically oriented members as there are vertically oriented uprights in the rigid frame and will be spaced identically to the spaces in the rigid frame such that all vertically oriented members of the cutting device align to a corresponding upright in the rigid frame. The leading edge of the vertical members of the cutting device will also be sharpened. The vertical members will have a plurality of attachment points that align to the attachment points in the vertically oriented uprights of the rigid frame. The cutting device will be fixed to the rigid frame utilizing bolts and properly torqued nuts. The cutting device will be hardened or made from an abrasion resistant material to increase the service life of the cutting device.

In accordance with the preferred form of the invention the depth limiting device is a plate or ski with an upturned leading edge to encourage the depth limiting device to slide over the surface of the ground. The depth limiting device will attach to the rigid frame with a pair of slidably engaged vertically oriented plates on each of the depth limiting device and the rigid frame. A plurality of hardened steel pins or the like with tool-less hairpin or similar devices meant to prevent removal and accidental dislodging of the pins will be inserted in to the orifices of the plates thus fixing the depth of cut for the invention. The number of pins will be equal to the number of banks of orifices on the invention, which will be determined by the specific construction of the various sizes in which this invention could manifest. The use of the tool-less pins will allow for the simple and efficient adjustment of the depth of cut by allowing for the moving of the depth limiting device without the need of tools.

In accordance with the preferred form of the invention the manner of connection to the tool carrier or tractor or the like will be specific to that machine, though many machines now have standardized connection devices or plates. Said connection plate will be attached to the rear edges of the vertically oriented uprights of the rigid frame. It is intended that this invention can be used by any tool carrier or tractor or the like regardless of the design of its connection device and is not limited to those machines with standardized connection devices.

### BRIEF DESCRIPTION OF THE SEVERAL VIEWS OF THE DRAWING

FIG. 1 is a side view of the invention.

FIG. 2 is a side view of the Rigid Frame.

FIG. 3 is a top view of the Rigid Frame.

FIG. 4 is a front view of the front vertically oriented plate on the rigid frame.

FIG. 5 is a front view of the rear vertically oriented plate on the depth limiting device.

FIG. 6 is a side view of the depth limiting device.

FIG. 7 is a side view of the cutting device.

FIG. 8 is an enlarged view of the left side when viewed from the front of the rear vertically oriented plate on the depth limiting device enlarged to show the detail of one bank of orifices used for setting the depth of cut.

FIG. 9 is an enlarged view of the left side when viewed from the front of the front vertically oriented plate on the depth limiting device enlarged to show the detail of one bank of orifices used for setting the depth of cut.

FIG. 10 is a view of one of the hardened steel pins with the tool-less securing device.

### DETAILED DESCRIPTION OF THE INVENTION

The invention is a method of adjusting and fixing the depth of cut of a sod or other vegetation cutting or surface planer device. Once attached to the tool carrier the invention is forced in to the ground and cutting of the earth is accomplished by the power and traction of the tool carrier. During operation the invention has no moving parts. The invention is easily adjustable as to depth of cut prior to operation utilizing the tool-less adjustment feature.

The following description of the invention is meant as an illustration and not a limitation. It is intended that the invention may be made to be any number of various sizes so as to allow for the customization of the device to the needs of the consumer and the capabilities of their tool carrier.

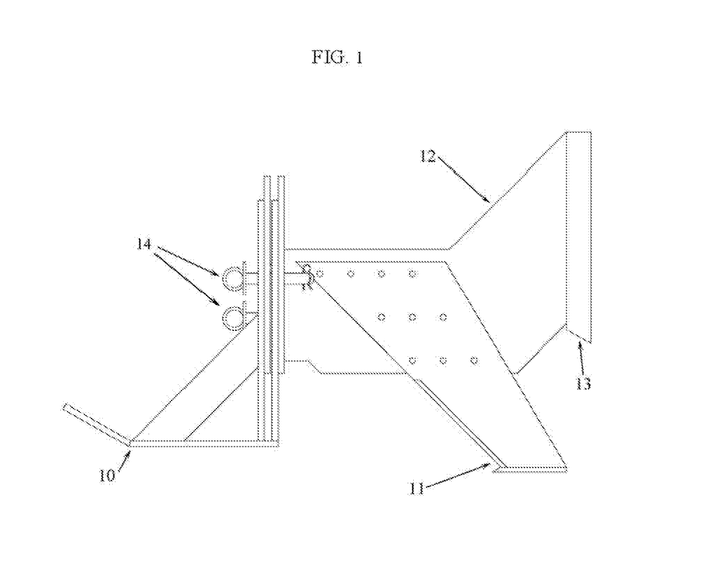

FIG. 1 is a side view of the invention showing the four main assemblies that make up the invention and how they connect to each other as well as the steel pins that fix the relative position of the slidably engaged assemblies thus setting the depth of cut. The depth limiting device 10 (Ski) slides over the surface of the ground to prevent the invention from being forced deeper in to the ground than is desired. The cutting device 11(Blade) which is the piece of the invention that is forced in to the ground and performs the cutting operations, is fixed to the rigid frame 12 with bolts and nuts and may be removed and replaced as needed using simple hand tools. The connection plate 13 is welded to and makes up the rear portion of the rigid frame 12 and is the manner in which the invention is connected to the tool carrier. This connection plate 13 may be a universal connection plate which is utilized by many modern tool carrier machines or may be customized to fit on the tool carrier of the consumer's choice.

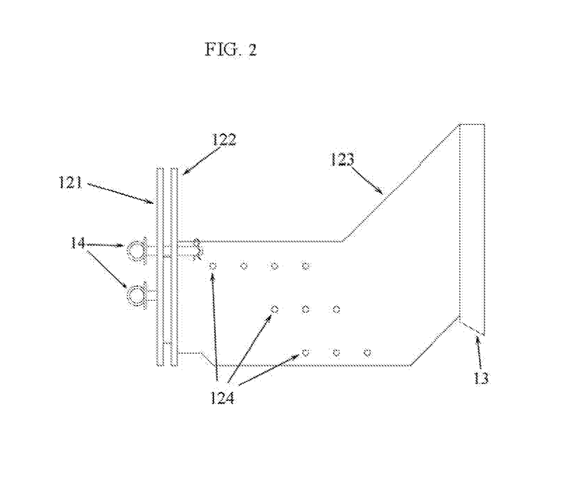

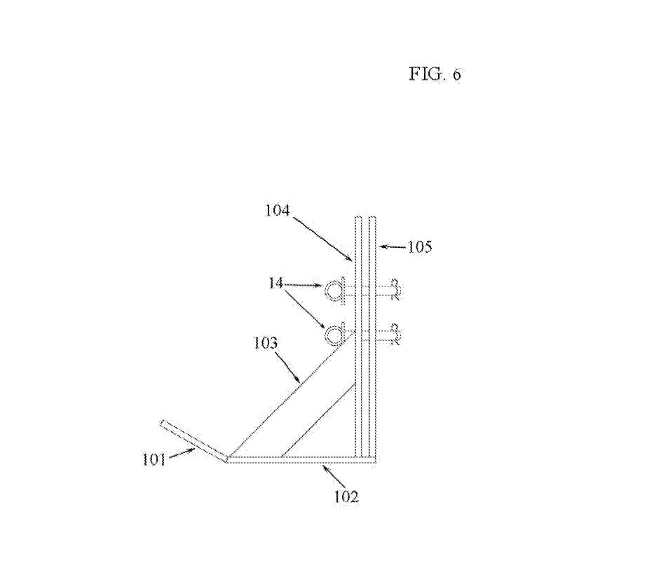

FIG. 2 shows a detailed side view of the rigid frame 12 and the various pieces that make up the rigid frame 12. All members of the rigid frame shown are oriented vertically so as to provide the maximum structural resistance to bending while the tool carrier is forcing the invention downward in to the earth during operation. The front plate 121 and rear plate 122 are oriented perpendicular to the direction of travel and serve as the interface and connection point between the rigid frame 12 and the depth limiting device 10. The plates 121 and 122 are welded to the vertical uprights 123 and the spacing between 121 and 122 is such that it allows for the slidable engagement with the rear plate 105 of the depth limiting device 10 being positioned between 121 and 122 and the front plate 104 of the depth limiting device 10 being positioned in front of 121. This configuration also results in the front plate 121 of the rigid frame 12 sliding between the vertical plates 104 and 105 as shown in FIG. 1 and FIG. 6. The vertical uprights 123 of the rigid frame 12 are oriented parallel to the direction of travel and contain the bolt holes 124 to which the cutting device 11 is bolted. In the preferred form there are three vertical uprights 123 but in other forms there will be as many as is necessary based on the size and width of the particular construction of the invention which will be determined by the size and power of the tool carrier and the needs and desires of the consumer.

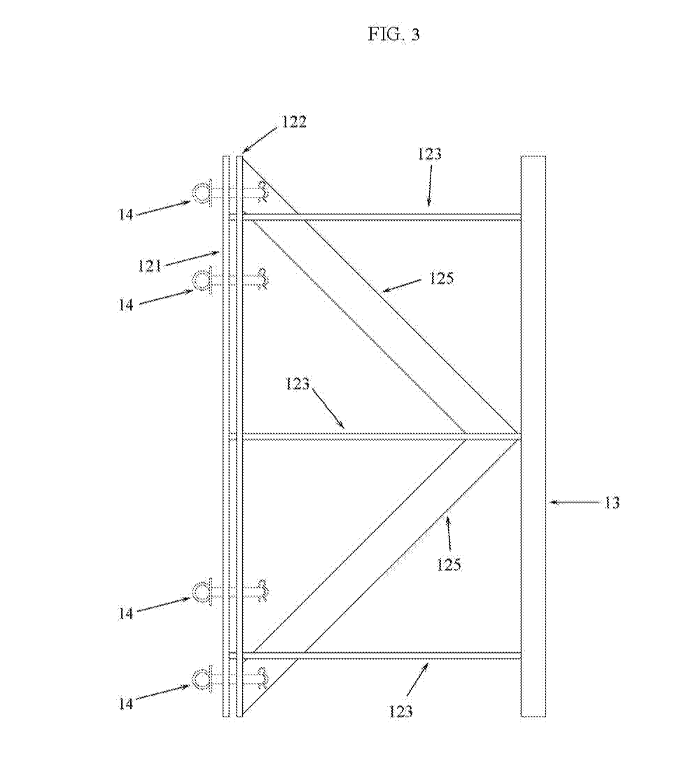

FIG. 3 shows the top view of the rigid frame assembly 12 and serves to illustrate how open the design is to prevent any sort of clogging of the cutting device 11. In this illustration there are three vertical uprights 123 sized to create two equal width cutting swaths. This configuration will allow for the attachment of a cutting device 11 that is the full width of the space between the outer vertical uprights 123 with two cutting swaths or one that is exactly half the width with a single cutting swath utilizing the center vertical upright 123 and either of the outer vertical uprights 123. Other configurations may have more than three vertical uprights 123 depending upon the size and power of the tool carrier and the width of cutting swath desired by the consumer. This view also illustrates well how the rigid frame 12 is constructed in that the vertical uprights 123 pierce the rear plate 122 completely and partially pierce the front plate 121. Diagonal supports 125 are located so as to lend structural integrity to the rigid frame 12 and to be well clear of the ground during operation thus preventing clogging. All pieces are permanently attached by the necessary means of joining the material that makes up the invention. In this example of all steel construction the connections are made by welding.

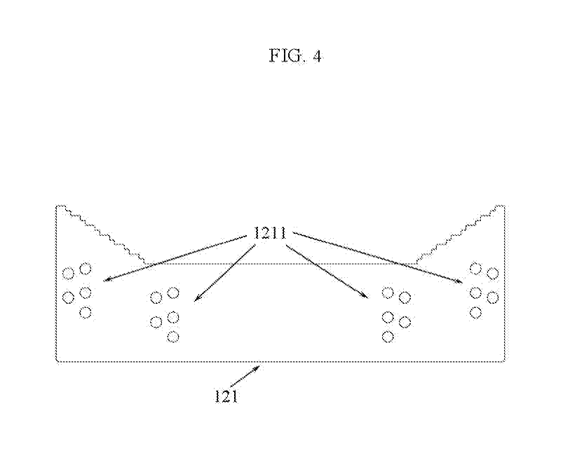

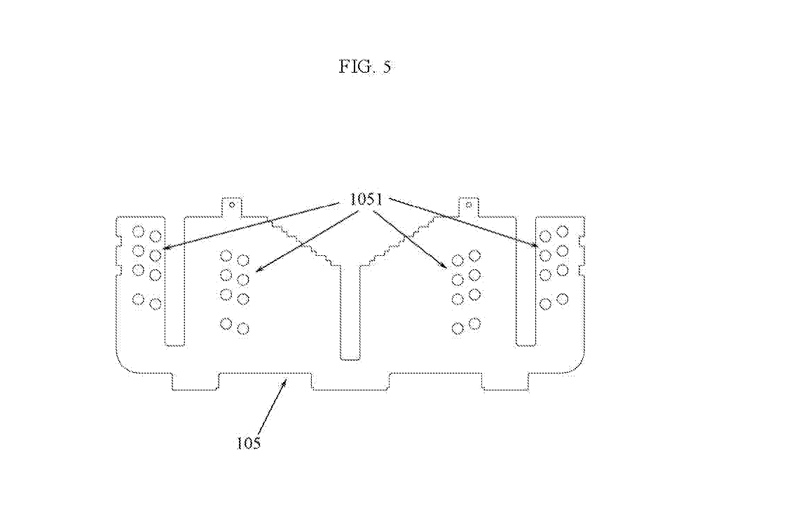

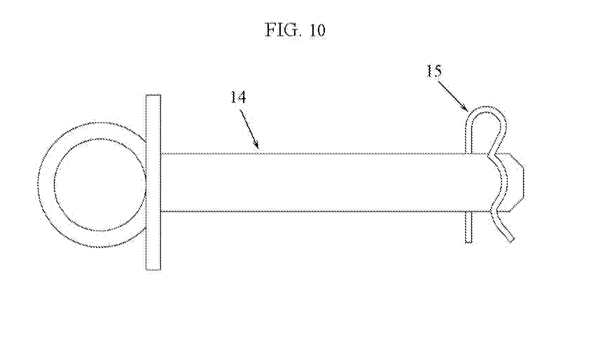

FIG. 4 shows the front view of the front plate 121 of the rigid frame 12 with the previously mentioned banks of orifices 1211 which will allow for the tool-less secured 15 hardened steel pins 14 shown in FIG. 10 to be removed and reinserted to fix the depth of cut. The banks of orifices 1211 on the front plate 121 match exactly to the same orifices on the rear plate 122, and are complimentary and coincidental to the banks of orifices 1051 in the vertical plates 104 and 105 of the depth limiting device 10 as shown in FIG. 5. The banks of orifices 1211 and 1051 are complimentary and coincidental in such a way that as the depth limiting device 10 is either raised or lowered in relation to the rigid frame 12 in half inch increments a different orifice in each pair of plates will come in to alignment so that the insertion of the hardened steel pins 14 in to said aligned orifices and then securing of the hardened steel pins 14 with the tool-less securing device 15 will fix the depth limiting device 10 to the rigid frame 12 in their new relative positions thus setting the depth of cut for the invention.

FIG. 6 is a side view of the depth limiting device 10 and shows the construction of its parts. The raised leading edge (ski tip) 101 is welded to the deck 102 at such an angle that it prevents the deck 102 from digging in to the ground and promotes sliding over the ground surface. Diagonal supports 103 are placed so as to provide structural stiffness to the depth limiting device assembly 10 by connecting the deck 102 to the front vertical upright 104. The Rear vertical upright 105 is welded to the deck 102 and the spacing between 104 and 105 is such that it allows for the slidable engagement with the front plate 121 of the rigid frame 12 being positioned between 104 and 105 and the rear plate 122 of the rigid frame 12 being positioned behind 105. This configuration results in the front plate 121 of the rigid frame 12 sliding between the vertical plates 104 and 105 as shown in FIG. 1 and FIG. 2.

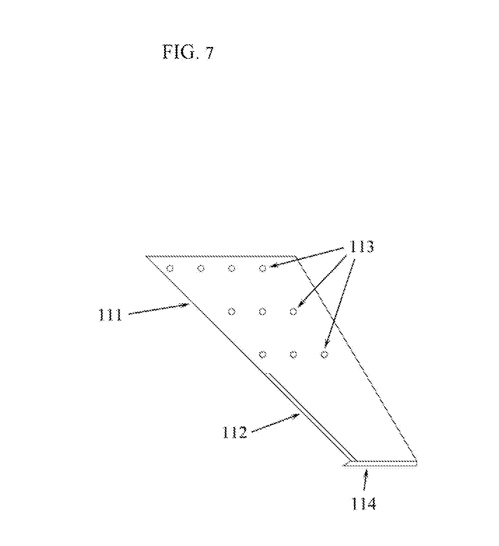

FIG. 7 is a side view of the cutting device 11 which is bolted to the rigid frame 12 via the plurality of bolt holes 124 in the vertical uprights 123 of the rigid frame 12 as well as the matching plurality of bolt holes 113 in the vertical uprights 111 of the cutting device 11. This view also shows how the vertical upright 111 has a sharpened leading edge 112. The horizontal member of the cutting device 114 has a sharpened leading edge as well and is welded to the bottom of the vertical uprights 111. The cutting device 11 has three vertical uprights 111 as there are three vertical uprights 123 on the rigid frame 12, a second interchangeable cutting device will have only two vertical uprights 111 when only a single cutting swath is desired. The spacing between the vertical uprights 111 of the cutting device 11 will match the spacing of the vertical uprights 123 of the rigid frame 12 so as to allow for easy attachment of the cutting device 11 to the rigid frame 12 by bolting through the aligned bolt holes 113 and 124 using simple hand or power tools. The entire cutting device 11 is made to be a wear item that is disposable and easily replaceable by anyone with the basic ability of using hand tools.

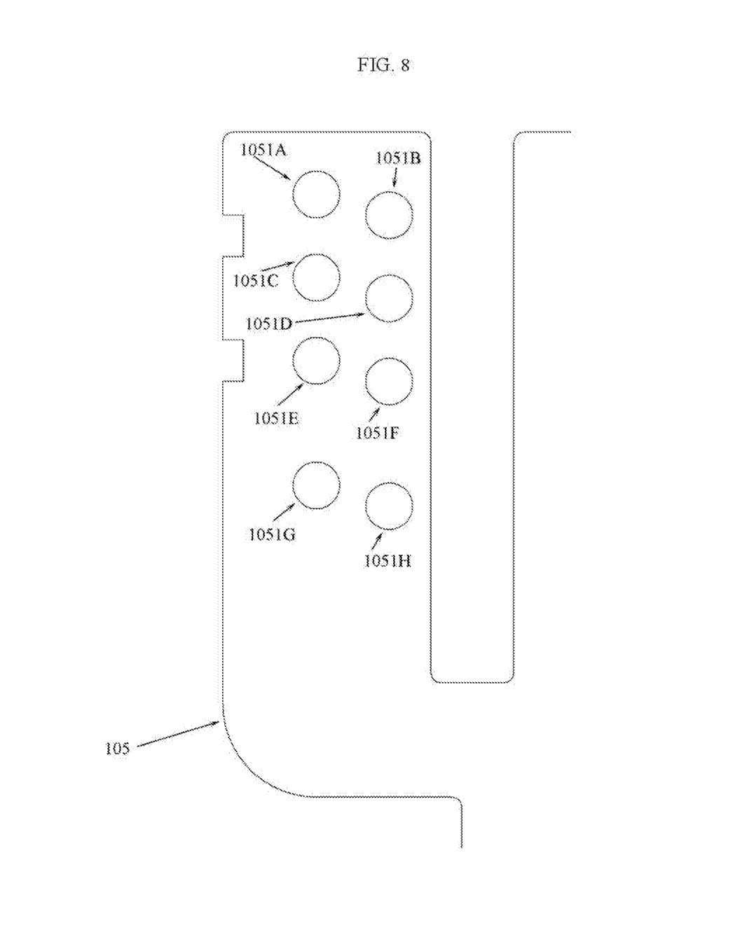

FIG. 8 is an enlarged view of the left side when viewed from the front of the rear vertically oriented plate 105 on the depth limiting device 10 enlarged to show the detail of the bank of orifices 1051 used for setting the depth of cut. This bank of orifices 1051 and all other banks of orifices 1051 on this part 105 are identical or a mirror image and are matched to an equal number of orifice banks in part 104 and here are further identified and labeled such that each orifice has its own letter designation such as 1051A, 1051B, 1051C, 1051D, 1051E, 1051F, 1051G, 1051H.

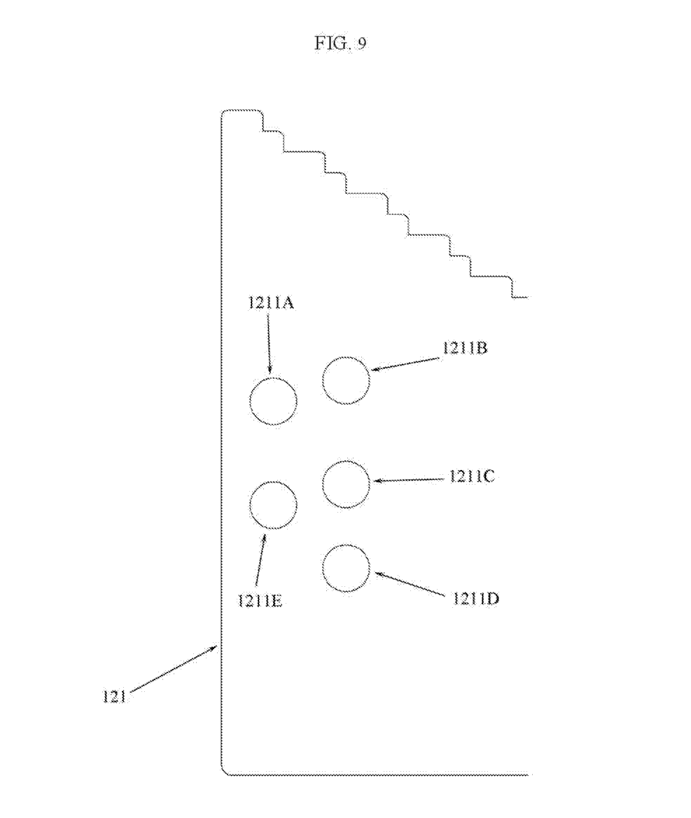

FIG. 9 is an enlarged view of the left side when viewed from the front of the front vertically oriented plate 121 on the rigid frame 12 enlarged to show the detail of the bank of orifices 1211 used for setting the depth of cut. This bank of orifices 1211 and all other banks of orifices 1211 on this part 121 are identical or a mirror image and are matched to an equal number of orifice banks in part 122 and here are further identified and labeled such that each orifice has its own letter designation such as 1211A, 1211B, 1211C, 1211D, 1211E.

When an adjustment to the depth of cut of the invention is desired the user will remove the tool-less securing device 15 from the hardened steel pins 14 and then remove the hardened steel pins 14 and then adjust the relative position of the depth limiting device 10 to the rigid frame 12. When the desired depth of cut has been found the hardened steel pins 14 will be re-inserted in to the aligning orifices in all banks of orifices and the tool-less securing device 15 will be reinserted in to the hardened steel pin 14 thus securing the depth limiting device 10 to the rigid frame 12 and effectively setting the depth of cut for the invention. In setting the depth of cut of the invention the following combinations of orifice alignments will be used for the specified depth of cut. Depth of cut 6 inches will align orifices 1051H and 1211C. Depth of cut 5.5 inches will align orifices 1051F and 1211B. Depth of cut 5 inches will align orifices 1051G and 1211E. Depth of cut 4.5 inches will align orifices 1051E and 1211A. Depth of cut 4 inches will align orifices 1051H and 1211D. Depth of cut 3.5 inches will align orifices 1051D and 1211B. Depth of cut 3 inches will align orifices 1051F and 1211C. Depth of cut 2.5 inches will align orifices 1051C and 1211A. Depth of cut 2 inches will align orifices 1051E and 1211E. Depth of cut 1.5 inches will align orifices 1051B and 1211B. Depth of cut 1 inch will align orifices 1051D and 1211C. Depth of cut 0.5 inches will align orifices 1051A and 1211A. Depth of cut 0 inches (storage and travel setting) will align orifices 1051C and 1211E.

### Alternative Embodiments

This embodiment is for a sod cutting device but this method could be utilized by any device in which the relative position of different assemblies needs to be adjusted and fixed. This method may be enlarged or miniaturized and banks of orifices can be added or subtracted to suit the size of the device being built. Increments of adjustment are shown in half inches in this embodiment but could be any size increments that would be advantageous to the application. This embodiment uses the method to adjust relative vertical position of the assemblies but this method could be applied to changing the relative position of assemblies on any plane or in any direction. This embodiment utilizes pairs of plates that slidably engage in only one dimension but this method could also be applied to pairs of plates that slidably engage in more than one dimension. The plates in this embodiment are planar, but this method could be used with curved plates allowing for adjustment on multiple dimensions and axes. This embodiment allows for the adjustment of the relative position of only two assemblies but this method could be utilized in the adjusting and fixing of the relative positions of a plurality of assemblies. This embodiment is made of steel, but could be built using any material suited to the application of the device which utilizes this method. This embodiment utilizes pins that are removed manually but other devices which utilize this method could use automated pin removal systems.

1. A method of adjusting the depth of cut of a sod or other vegetation cutting or surface planer device achieved through the use of two pairs of vertically aligned slidably engaged plates on parallel planes, one pair of plates attached to the depth limiting device of the sod cutter and the other pair attached to the rigid frame of the sod cutter, in each pair of plates, the plate that is oriented closest to the other assembly is arranged to be in between the other pair of plates, each plate in a pair containing the same number of a plurality of banks of matching orifices in a specific pattern that coincide with the specific matched pattern of orifices in the other pair of plates and fixed in relative vertical position to each other by linchpins inserted through aligned orifices in each of the pairs of plates; adjustment to depth of cut being achieved by removing the linchpins which fix the relative position of each assembly of the device followed by an adjustment to the relative position of each assembly to the other assembly and then reinserting the linchpins in to the newly aligned orifices of the pairs of plates thus fixing the new relative position of the assemblies in such a way that as the relative vertical position of each assembly of the device is changed, a plurality of incremental adjustments can be made to the relative position of the plates and the assemblies to which they are fixed without the use of tools.

2. The method according to claim 1 in which the method is utilized to incrementally adjust and fix the relative position of a plurality of assemblies of any device on a plurality of axes or planes.

3. The method according to claim 1 in which the removal and reinsertion of the linchpins is automated or accomplished through some other means than manual removal and reinsertion.
